(19) United States
(12) Patent Application Publication
(10) Pub. No.: US 2025/0385439 A1
(43) Pub. Date: Dec. 18, 2025

(54) CIRCULAR ARRAY ANTENNA

(71) Applicant: ACE Technologies Corporation, Incheon (KR)

(72) Inventors: Nyambayar JARGALSAIKHAN, Incheon (KR); Ho Yong KIM, Incheon (KR); Seung Chul LEE, Incheon (KR)

(21) Appl. No.: 19/233,408

(22) Filed: Jun. 10, 2025

(30) Foreign Application Priority Data
Jun. 17, 2024 (KR) 10-2024-0078133

(51) Int. Cl. H01Q 21/06; H01Q 21/20; H01Q 21/24

(52) U.S. Cl. CPC H01Q 21/062; H01Q 21/20; H01Q 21/24

(57) ABSTRACT

Disclosed herein are circular antennas that are miniaturized and have improved electrical performance. As an example, disclosed herein is a circular array antenna used in a wireless communication system, comprising a plurality of column units arranged at a predetermined angle, each column unit comprising: a connection port formed at one end and configured to transmit or receive power or a signal; a wiring structure coupled to the connection port; and at least one pair of dipoles formed in the wiring structure and protruding toward the other end, wherein the dipoles are formed in the wiring structure through a pattern and are integrally formed.

### CROSS-REFERENCE TO THE RELATED APPLICATION

The present application claims priority to and the benefit of Korean Patent Application No. 10-2014-0078133, filed on Jun. 17, 2024, in the Korean Intellectual Property Office, the entire disclosure of which is incorporated herein by reference.

### BACKGROUND

### 1. Field

The present invention relates to a circular array antenna that is miniaturized and has improved electrical performance.

### 2. Description of the Related Art

An array antenna can obtain the desired directivity with an array using two or more antenna elements simultaneously when a radiation pattern that cannot be obtained with a single antenna element is required. The array antennas are divided into linear array antennas, planar array antennas, and non-planar array antennas according to the geometry of the array elements, and the dual planar array antenna is divided into circular array antennas and rectangular array antennas.

In this case, the circular array antenna is widely applied to radar because it is possible to obtain a geometrical desired radiation pattern by changing the current phase of each element of the antenna array, and the circular array antenna in which the arrangement of the antennas is constant is widely used not only in wireless communication systems such as 4G, LTE, and 5G, but also in the field of direction detection technology.

The present invention provides a circular array antenna that is miniaturized and has improved electrical performance.

### SUMMARY

A circular array antenna according to the present invention is a circular array antenna used in a wireless communication system, including a plurality of column units arranged at a preset angle, each column unit comprising a connection port being formed at one end of the each column unit to transmit or receive power or a signal; a wiring structure coupled to the connection port; and at least one pair of dipoles formed of the wiring structure and protruding toward the other end, wherein the dipoles are formed in the wiring structure through a pattern and may be integrally formed.

Here, a balun formed through a pattern of the wiring structure may be further formed between the connection port and the dipole.

In addition, a power divider formed through the pattern of the wiring structure may be further formed between the connection port and the dipole.

In addition, a comb-shaped strip line formed in a periodic pattern may be further included on one surface of the wiring structure.

In addition, a phase shifter that varies in position relative to the strip line may be further included.

In addition, the phase shifter may be constructed of an insulator to adjust the exposed area of the strip line.

A housing surrounding one end of the wiring structure may be further included.

In addition, a reflector provided in a number corresponding to the column unit and including a plurality of surfaces respectively coupled to the column unit may be further included.

Additionally, the reflector may further include a hole through which the dipole of the column unit protrudes and is coupled.

In addition, a radome that covers the column units from the outside in a state in which a plurality of the column units are arranged.

Furthermore, the wiring structure may include at least one of a printed circuit board, a structure in which a conductive pattern is coated on an insulator substrate, or a structure in which part of a conductive wire is insert-injected into an insulator.

A circular array antenna according to an embodiment of the present invention may couple the respective components of the plurality of column units without separate cables or soldering. Therefore, since the cable or soldering process is removed and structural simplification is enabled, productivity in the manufacture of the column unit can be increased, quality can be improved, and PIMD (Passive Intermodulation Distortion) performance can be improved.

### BRIEF DESCRIPTION OF THE DRAWINGS

FIG. 1 is a perspective view of a circular array antenna according to an embodiment of the invention.

FIG. 2 is a cross-sectional view of a circular array antenna according to an embodiment of the present invention.

FIG. 3 is a perspective view illustrating a state in which a wiring structure is coupled to a reflector of a circular array antenna according to an embodiment of the present invention.

FIG. 4 is a perspective view illustrating a column unit of a circular array antenna according to an embodiment of the present invention.

FIG. 5 is a perspective view illustrating a form in which phase shifters are coupled in a column unit of a circular array antenna according to an embodiment of the present invention.

FIGS. 6A and 6B are perspective views illustrating a process in which a position of a phase shifter is changed according to a column unit of a circular array antenna according to an embodiment of the present invention.

FIG. 7 illustrates a pattern of omni beams in a circular array antenna according to an embodiment of the present invention.

FIGS. 8A and 8B illustrate odd and even arrays of columns in a circular array antenna, respectively, in accordance with an embodiment of the present invention.

FIGS. 9A and 9B illustrate the endfire beam pattern in an odd array and the endfire beam patterns in an even array of columns, respectively.

FIGS. 10A and 10B show the broadside beam pattern in an odd array and the broadside beam patterns in an even array of columns, respectively.

### DETAILED DESCRIPTION OF EXEMPLARY EMBODIMENTS

Hereinafter, preferred embodiments of the present invention will be described in detail with reference to the accompanying drawings.

Embodiments of the present invention are provided to explain the present invention more fully to those skilled in the art, and the following embodiments may be modified in various other forms, and the scope of the present invention is not limited to the following embodiments. Rather, these embodiments are provided to make the present disclosure more thorough and complete, and to fully convey the spirit of the present invention to those skilled in the art.

In addition, the thickness or size of each layer in the following drawings is exaggerated for convenience and clarity of description, and like reference numerals refer to like elements in the drawings. As used herein, the term “and/or” includes any one and all combinations of one or more of the listed items. In the present specification, the term “connect” means not only the case where the A member and the B member are directly connected, but also the case where the C member is interposed between the A member and B member and the A member is indirectly connected to the B member.

The terminology used herein is for the purpose of describing particular embodiments and is not intended to limit the invention. As used herein, the singular forms “a,” “an,” and “the” can include plural referents unless the context clearly dictates otherwise. Also, as used herein, “comprise” and/or “comprising” are intended to specify the presence of stated shapes, numbers, steps, operations, members, elements, and/or groups thereof, and are not intended to exclude the presence or addition of one or more other shape, number, operation, member, element, and/or group.

Although the terms first, second, and the like are used herein to describe various members, parts, regions, layers, and/or portions, it is apparent that these members, parts, region, layers and/or portions should not be limited by these terms. These terms are used only to distinguish one member, part, region, layer or portion from another region, layer or part. Thus, a first member, part, region, layer or portion, which will be described in detail below, may refer to a second member, part, area, layer or portion without departing from the teachings of the present invention.

Space-related terms such “beneath,” “below,” “lower,” “above,” and “upper” are used for easy understanding of elements or features that differ from one element or feature shown in the figures. These space-related terms are intended for the easy understanding of the present invention depending on the various process states or use states of the present invention, and are not intended to limit the present invention. For example, when an element or feature of a figure is inverted, an element described as “bottom” or “below” becomes “top” or “above”. Thus, “below” is a concept encompassing “above” or “below. Thus, “below” is a concept encompassing “above” or “below.

Hereinafter, a configuration of a circular array antenna according to an embodiment of the present invention will be described.

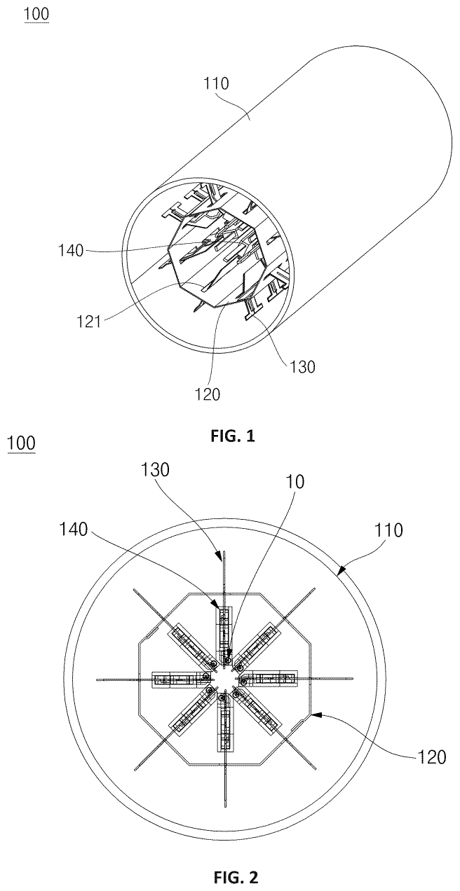

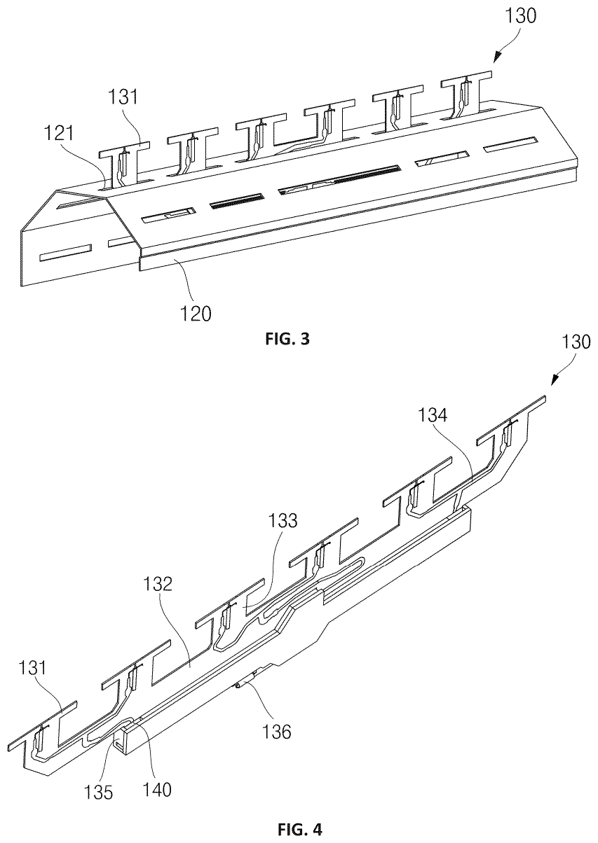

FIG. 1 is a perspective view of a circular array antenna according to an embodiment of the invention. FIG. 2 is a cross-sectional view of a circular array antenna according to an embodiment of the present invention. FIG. 3 is a perspective view illustrating a state in which a wiring structure is coupled to a reflector of a circular array antenna according to an embodiment of the present invention. FIG. 4 is a perspective view illustrating a column unit of a circular array antenna according to an embodiment of the present invention.

Referring first to FIG. 1, a circular array antenna 100 according to an embodiment of the present invention may include a radome 110, a reflector 120, a column unit 130, and a housing 140.

The radome 110 may have a hollow cylindrical shape. The radome 110 may serve to protect devices within the antenna 100 from weather phenomena such as rain, snow, or strong winds. The radome 110 may be made of an insulating material, for example, a glass fiber or a polyester fiber, which has less propagation loss due to absorption during transmission and reception of radio waves.

The reflector 120 may refer to a reflector used when radio waves radiated from the antenna 100 are concentrated (Beam) in a desired direction to reach a greater distance or to increase sensitivity of a received input. The reflector 120 may be made of metal to increase reflectivity, and may have a shape corresponding to the number and arrangement of column units 130 therein. For example, the reflector 120 may be configured in the form of an octagonal pillar having eight faces to correspond with the column unit 130.

On the other hand, the reflector 120 may be configured to have a hole 121 on each surface so that a part (dipole) of the column unit 130 protrudes through the hole 121. This configuration allows the reflector 120 to be coupled with each column unit 130.

A plurality of column units 130 may be provided and coupled to the reflector 120. Each column unit 130 may include a dipole 131, a wiring structure 132, a balun 133, a power divider 134, a strip line 135, a connection port 136, and a phase shifter 137.

Of these, the dipoles 131 may have a paired configuration, and the length of each dipole 131 may be selected based on the wavelength λ of the signal to be transmitted and received. For example, the length of each dipole 131 may be selected to be at least ¼ of the length of the wavelength A and at least ½ of the wavelength A with respect to a pair.

The wiring structure 132 may be configured to include the dipole 131 therein via an internal pattern and may also provide a path for connecting the dipole 131 with other components 132-135 within the column unit 130. To this end, for example, the wiring structure 132 may be formed of one single printed circuit board (PCB) In addition, for example, the wiring structure 132 may be formed of a wiring substrate in which a conductive pattern is coated on a substrate that is an insulator. In addition, for example, the wiring structure 132 may be formed as a structure in which at least a part of the conductive wire is inserted into an insulator based on the conductive wire. The wiring structure 132 may be electrically connected through an internal circuit pattern in forming each of the components 131 to 136. Accordingly, through the wiring structure 132, the respective components 131 to 136 of the column unit 130 can be coupled without separate cables or soldering. Therefore, the cable or soldering process is eliminated, and structural simplification is enabled, so that productivity in the manufacture of the column unit 130 can be enhanced, and PIMD (Passive Intermodulation Distortion) performance can be improved.

Balun 133 refers to a device that performs signal conversion between a balanced circuit and an unbalanced circuit. Examples of the balanced circuit include a single-ended circuit, a coaxial cable, and the like, and examples of the unbalanced circuit include a dipole, a differential mode circuit, and the like. The balun 133 is configured to connect a “single-ended port” and a “differential port” to perform signal conversion between the balanced circuit and the unbalanced circuit.

The power divider 134 may also be configured through an internal pattern of the wiring structure 132, and may distribute a signal input from the connection port 136 to each dipole 131. Further, the power distributor 134 may communicate signals received at each dipole 131 to the connection port 136.

The strip line 135 may be formed of a comb-shaped metal pattern of a periodic structure, and may be formed in a pattern on the wiring structure 132. In addition, one surface of the strip line 135 is exposed, and the exposed surface may be selectively covered by the phase shifter 137. The strip line 135 may increase or decrease in exposed area depending on the relative position of the phase shifter 137, and thus the phase set for the entire column unit 130 may vary. For example, an area of the strip line 135 that is not covered by the phase shifter 137 is exposed to air, and conversely, an area covered by the phase-shifter 137 is covered by a dielectric.

Hence, if the region covered by the air and the dielectric of the strip line 135 is set differently, the impedance may be changed and the phase of each column unit 130 may be changed. For example, as the area of the strip line 135 covered by the phase shifter 137 increases, the phase of the column unit 130 may be delayed.

Connection port 136 may be formed at one end of each column unit 130 and may be connected to a coaxial cable (not shown) in an antenna of the overall structure. Power and/or signals required for signal transmission and/or reception may be transmitted from or towards the coaxial cable via the connection port 136.

The phase shifter 137 is coupled to the aforementioned strip line 135, and the relative position can be varied, such that the phase of the column unit 130 can be varied. That is, the phase shifter 137, in conjunction with the strip line 135, performs a phase change of the column unit 130. The configuration and operation of the phase shifter 137 will be described in more detail below with reference to the drawings.

The housing 140 is formed to enclose a portion of the column unit 130, and may enclose, for example, the strip line 135, the connection port 136, and the phase shifter 137 of the column unit 140 to protect against external shocks or strong winds, rain, snow, or the like.

Hereinafter, the detailed configuration and operation of the phase shifter 137 of the column unit 130 will be described in more detail.

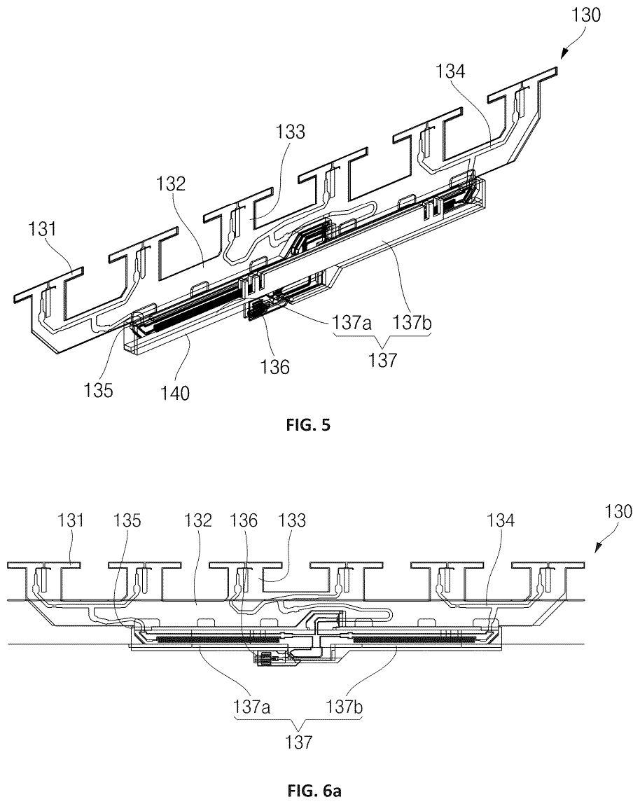

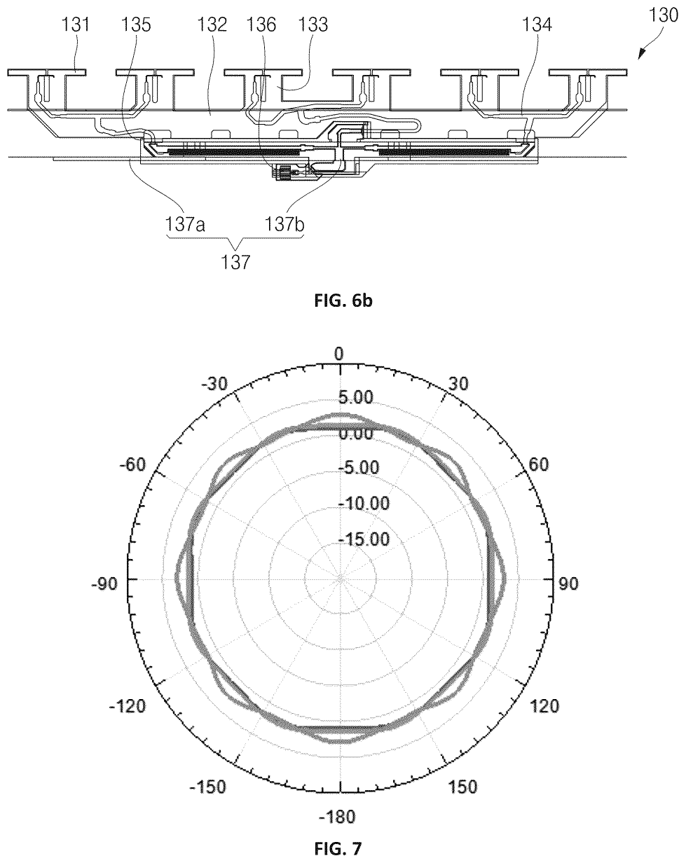

FIG. 5 is a perspective view illustrating a form in which a phase shifter is coupled in a column unit of a circular array antenna according to an embodiment of the present invention. FIGS. 6A and 6B are perspective views illustrating a process in which a position of a phase shifter is changed in a column unit of a circular array antenna according to an embodiment of the present invention.

Referring to FIG. 5, the phase shifter 137 of the column unit 130 may be coupled to cover a surface to which the strip line 135 is exposed. The phase shifter 137 is configured to include a first region 137a coupled along a bottom of the column unit 180 and a second region 137b which faces the strip line 135.

The first region 137a may move along a lower end of the column unit 130 such that the phase shifter 137 is rigidly coupled to the column unit 130. Further, the second region 137b is integrally formed with the first region 137a and may move relative to the strip line 135 to cover a portion of the region.

Referring now to FIG. 6A, an initial position of phase shifter 137 on column unit 130 is shown, and referring to FIG. 6B, a state in which phase shifter 137 has moved relatively to the left of the figure from the initial position is shown. In this case, the area of the strip line 135 covered by the phase shifter 137 may be reduced relative to the initial position, and the phase of the column unit 130 may be delayed relatively.

The operation of this phase shifter 137 may be performed simultaneously on all column units 130, or may be performed differently on each column unit 130. Further, the phase shifter 137 may be remotely controlled by a Remote Electric Tilt (RET) mechanism as well as manual control.

Hereinafter, a signal pattern through a circular array antenna according to an embodiment of the present invention will be exemplarily described.

FIG. 7 illustrates a pattern of an omni beam in a circular array antenna in accordance with an embodiment of the present invention.

Referring to FIG. 7, it can be seen that all eight column units 130 constituting the circular array antenna 100 according to an embodiment of the present invention have the same amplitude and phase.

That is, it can be seen that the circular array antenna 100 according to an embodiment of the present invention is suitable for use as an omni beam pattern.

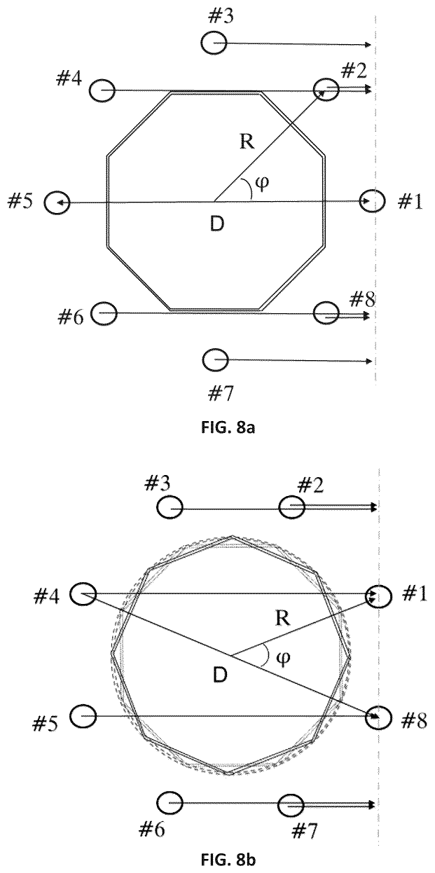

FIGS. 8A and 8B illustrate odd and even arrays of column units in a circular array antenna, respectively, in accordance with an embodiment of the present invention.

FIG. 8A illustrates an odd array and FIG. 8B illustrates an even array of methods for configuring a circular antenna array of eight column units 130, respectively. The odd array and the even array are two arrays for steering an azimuth beam through each column unit 130, and there may be a difference in the phase of the column units 130 arranged according to the arrangement direction.

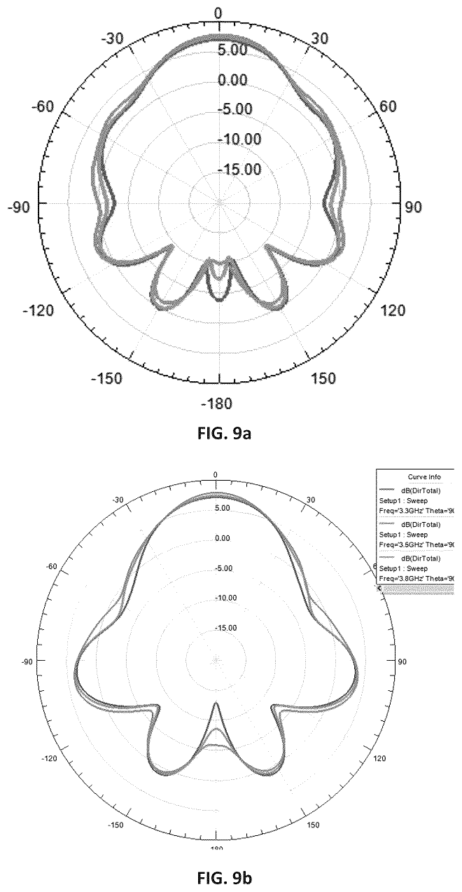

Next, FIGS. 9A and 9B illustrate the endfire beam pattern in an odd array and the endfire beam patterns in an even array of columns, respectively.

When the phase of the desired first column unit #1 in the odd array is referenced to 0 degrees, the remaining column units #2 to #8 in the odd and even arrays each have an end fire beam pattern in a form in which the phase is delayed and symmetrical with respect to the first column unit #1, respectively.

For example, the power (amplitude) and phase of the end fire beam pattern in the odd array and the even array are as follows.

TABLE 1

| End Fire Beam | | Number of Radiator for End Fire Beam | | | | | | | |
|---|---|---|---|---|---|---|---|---|---|
| configuration | Parameter | #1 | #2 | #3 | #4 | #5 | #6 | #7 | #8 |
| Odd (a) | Power | 1 | 1 | 0.8 | 0.35 | 0.35 | 0.35 | 0.8 | 1 |
| | Phase | 0 | FP1-0.162λ | FP2-0.45λ | FP3-0.5λ | FP4-0.5λ | #4 | #3 | #2 |
| Even (b) | Power | 1 | 0.8 | 0.5 | 0.35 | 0.35 | 0.5 | 0.8 | 1 |
| | Phase | 0 | FP1-0.214λ | FP2-0.616λ | FP3-0.5λ | #4 | #3 | #2 | #1 |

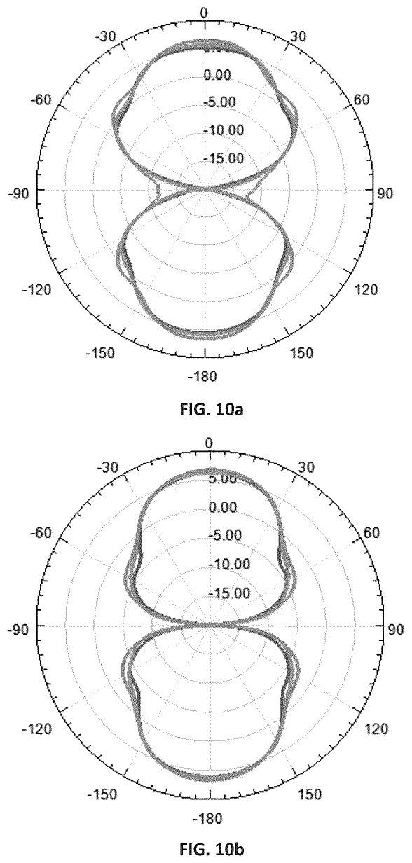

Meanwhile, FIGS. 10A and 10B illustrate a broadside beam pattern in an odd array and a broadside beam patterns in an even array of columns, respectively.

Also, when the phase of the desired first column unit #1 in the odd array is based on 0 degrees, the remaining column units #2 to #8 in the odd array and the even array each have a broadside beam pattern in a form in which the phase is delayed and symmetrical with respect to the first column unit #1, respectively.

For example, the power (amplitude) and phase of the broadside beam pattern in the odd and even arrays are as follows.

TABLE 2
Broadside

| Beam | | Number of Radiator for Broad-side Beam | | | | | | | |
|---|---|---|---|---|---|---|---|---|---|
| configuration | Parameter | #1 | #2 | #3 | #4 | #5 | #6. | #7 | #8 |
| Odd (a) | Power | 1 | 1 | 0.5 | 1 | 1 | 1 | 0.5 | 1 |
| | Phase | 0 | FP1-0.157λ | FP2-0.4λ | #5 + #2 | FP4-0.792λ | #5 + #2 | #3 | #2 |
| Even (b) | Power | 1 | 0.8 | 0.8 | 1 | 0.35 | 0.8 | 0.8 | 1 |
| | Phase | 0 | FP1-0.166λ | #4 + #2 | −0.48λ | #4 | #4 + #2 | #2 | #1 |

Accordingly, it can be seen that the circular array antenna 100 according to an embodiment of the present invention is suitable for replacing three separate beam sectors used in an existing base station or the like through one circular array antenna.

The above description is merely one embodiment for implementing the circular array antenna according to the present invention, and the present invention is not limited to the above embodiment, and it is to be understood that there is a technical spirit of the present invention to the extent that various modifications can be implemented by any person skilled in the art without departing from the gist of the present invention as claimed in the following claims.

What is claimed is:

1. A circular array antenna used in a wireless communication system, comprising a plurality of column units arranged at a predetermined angle, each column unit comprising:
a connection port formed at one end and configured to transmit or receive power or a signal; a wiring structure coupled to the connection port; and
at least one pair of dipoles formed in the wiring structure and protruding toward the other end,
wherein the dipoles are formed in the wiring structure through a pattern and are integrally formed.

2. The circular array antenna according to claim 1, wherein a balun is further formed through a pattern of the wiring structure between the connection port and the dipole.

3. The circular array antenna according to claim 1, wherein a power distributor is further formed through a pattern of the wiring structure between the connection port and the dipole.

4. The circular array antenna according to claim 1, wherein a comb-shaped strip line formed in a periodic pattern is further provided on one surface of the wiring structure.

5. The circular array antenna according to claim 4, wherein a phase shifter that varies in position relative to the strip line is further included.

6. The circular array antenna according to claim 5, wherein the phase shifter is composed of an insulator to control an exposed region of the strip line.

7. The circular array antenna according to claim 1, further comprising:
a housing surrounding one end of the wiring structure.

8. The circular array antenna according to claim 1, further comprising:
a reflector provided in a number corresponding to the column unit and including a plurality of surfaces respectively coupled to the column unit.

9. The circular array antenna according to claim 8, wherein the reflector further includes a hole through which the dipole of the column unit protrudes and is coupled.

10. The circular array antenna according to claim 1, further comprising:
a radome covering the column units from the outside in a state where a plurality of the column units are arranged.

11. The circular array antenna according to claim 1, wherein the wiring structure includes at least one of a printed circuit board, a structure in which a conductive pattern is coated on an insulator substrate, or a structure in which part of a conductive wire is insert-injected into an insulator.
